(19) United States
(12) Patent Application Publication
(10) Pub. No.: US 2022/0376407 A1
(43) Pub. Date: Nov. 24, 2022

(54) BASE STATION ANTENNAS INCLUDING RADIATING ELEMENTS HAVING OUTER DIPOLE ARMS THAT CONFORM TO CURVED TRANSITION WALLS OF A RADOME

(71) Applicant: CommScope Technologies LLC, Hickory, NC (US)

(72) Inventors: Maosheng Liu, Suzhou (CN); Rui An, Richardson, TX (US); ZhaoHui Liu, Suzhou (CN); Bo Wu, Richardson, TX (US)

(21) Appl. No.: 17/748,955

(22) Filed: May 19, 2022

Related U.S. Application Data
(60) Provisional application No. 63/191,492, filed on May 21, 2021.

(51) Int. Cl. H01Q 21/26; H01Q 1/24; H01Q 21/24; H01Q 3/16

(52) U.S. Cl. CPC H01Q 21/26; H01Q 1/246; H01Q 21/245; H01Q 3/16

(57) ABSTRACT

Base station antennas comprise a planar reflector, a radiating element mounted to extend forwardly from the planar reflector, the radiating element including a dipole that comprises an inner dipole arm and an outer dipole arm, and a radome having a front wall, a side wall and a curved front transition wall that connects the front wall to the side wall. A distal end of the outer dipole arm is closer to the planar reflector than is a base of the outer dipole arm, and an overlap portion of the outer dipole arm overlaps the curved front transition wall. A largest minimum distance between any point on a front surface of the overlap portion of the outer dipole arm and the radome is less than twice a smallest minimum distance between any point on the front surface of the overlap portion of the outer dipole arm and the radome.

### CROSS-REFERENCE TO RELATED APPLICATION

The present application claims priority under 35 U.S.C. § 119 to U.S. Provisional Application Ser. No. 63/191,492, filed May 21, 2021, the entire content of which is incorporated herein by reference as if set forth in its entirety.

### FIELD

The present invention generally relates to cellular communications and, more particularly, to base station antennas for cellular communications systems

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. Typically, a base station antenna includes a plurality of phase-controlled arrays of radiating elements, with the radiating elements arranged in one or more vertically-extending columns that are often referred to as “linear arrays.” Each linear array generates an antenna beam or, if the linear array is formed using dual-polarized radiating elements, forms an antenna beam at each of two orthogonal polarizations. Base station antennas further include a radome, which refers to an outer housing that encloses and protects the radiating elements. At least a front surface of the radome is typically designed to be transparent to RF signals within the operating frequency bands of the linear arrays of radiating elements.

As demand for cellular service has grown, cellular operators have upgraded their networks to increase capacity and to support new generations of cellular service. Most recently, base station antennas are being deployed that support so-called fifth generation or “5G” cellular service. When these new services are introduced, the existing services typically must be maintained to support legacy mobile devices. Accordingly, many base station antennas that support fourth generation (“4G”) and 5G service include many different arrays of radiating elements that support cellular service in different operating frequency bands. As the number of arrays of radiating elements included in a base station is increased, the size of the base station antenna also typically increases.

Base station antennas are often mounted on tall antenna towers, and may be subject to very high wind levels. The term “wind load” refers to the forces that wind exerts on a structure, such as a base station antenna. As the size of a base station antenna increases, the amount of wind loading also generally increases. The base station antenna, its mounting hardware, and even the antenna tower must be designed to withstand anticipated amounts of wind loading, and hence larger base station antennas may require the use of more rigid radomes and/or sturdier mounting brackets, and may limit the number of base station antennas that can be mounted on an antenna tower (or, alternatively, require structural reinforcement of the tower).

### SUMMARY

Pursuant to embodiments of the present invention, base station antennas are provided that include a backplane having a planar reflector, a radiating element mounted to extend forwardly from the planar reflector, the radiating element including a dipole that comprises an inner dipole arm and an outer dipole arm, and a radome having a front wall, a side wall and a curved front transition wall that connects the front wall to the side wall. A distal end of the outer dipole arm is closer to the planar reflector than is a base of the outer dipole arm, and an overlap portion of the outer dipole arm overlaps the curved front transition wall, Additionally, a largest minimum distance between any point on a front surface of the overlap portion of the outer dipole arm and the radome is less than twice a smallest minimum distance between any point on the front surface of the overlap portion of the outer dipole arm and the radome.

In some embodiments, the overlap portion of the outer dipole arm may be at least half a length of the outer dipole arm.

In some embodiments, the curved front transition wall may have a radius of curvature of at least 50 mm or a radius of curvature of at least 75 mm.

In some embodiments, the radiating element may be configured to operate in at least a portion of the 617-960 MHz frequency band.

In some embodiments, the largest minimum distance between any point on the front surface of the overlap portion of the outer dipole arm and the radome may be less than 1.5 times the smallest minimum distance between any point on the front surface of the overlap portion of the outer dipole arm and the radome.

In some embodiments, the largest minimum distance between any point on the front surface of the overlap portion of the outer dipole arm and the radome may be less than 1.25 times the smallest minimum distance between any point on the front surface of the overlap portion of the outer dipole arm and the radome.

In some embodiments, the outer dipole arm may include at least two bends along a longitudinal axis of the outer dipole arm that divide the outer dipole arm into a plurality of longitudinally-extending sections that are angled with respect to each other. In some embodiments, distances between centers of each longitudinally-extending section and respective closest points on the radome may vary by less than 25%.

Pursuant to further embodiments of the present invention, base station antennas are provided that include a backplane having a reflector, a radiating element mounted to extend forwardly from the reflector, the radiating element including an inner dipole arm and an outer dipole arm, and a radome that has a front wall that is positioned in front of the radiating element. The outer dipole arm includes at least two bends along a longitudinal axis of the outer dipole arm that divide the outer dipole arm into a plurality of longitudinally-extending sections that are angled with respect to the reflector and with respect to each other, where distances between centers of each longitudinally-extending section and respective closest points on the radome vary by less than 50%.

In some embodiments, the distances between the centers of each longitudinally-extending section and the respective closest points on the radome may vary by less than 25%.

In some embodiments, the radome may further include a side wall and a curved front transition wall that connects the front wall to the side wall, and the curved transition wall may have a radius of curvature of at least 50 mm.

In some embodiments, the radome may further include a side wall and a curved front transition wall that connects the front wall to the side wall, and the curved transition wall may have a radius of curvature of at least 90 mm.

In some embodiments, the radiating element may be configured to operate in at least a portion of the 617-960 MHz frequency band.

In some embodiments, the radome may further include a side wall and a curved front transition wall that connects the front wall to the side wall, and an overlap portion of the outer dipole arm overlaps the curved front transition wall may be at least half a length of the outer dipole arm.

In some embodiments, a largest minimum distance between any point on a front surface of the overlap portion of the outer dipole arm and the radome may be less than 1.5 times a smallest minimum distance between any point on the front surface of the overlap portion of the outer dipole arm and the radome.

Pursuant to further embodiments of the present invention, base station antennas are provided that include a reflector, a radome having a front wall, a side wall and a curved front transition wall that connects the front wall to the side wall, the curved front transition wall having a radius of curvature of at least 50 mm, and a radiating element mounted to extend forwardly from the reflector, the radiating element including an inner dipole arm and an outer dipole arm. An overlap portion of the outer dipole arm overlaps the curved front transition wall, and a largest minimum distance between any point on a front surface of the overlap portion of the outer dipole arm and the radome is less than 1.5 times a minimum distance between the front wall of the radome and the front surface of the outer dipole arm.

In some embodiments, the curved front transition wall may have a radius of curvature of at least 90 mm.

In some embodiments, the radiating element may be configured to operate in at least a portion of the 617-960 MHz frequency band.

In some embodiments, the largest minimum distance between any point on the front surface of the overlap portion of the outer dipole arm and the radome may be less than 1.5 times a smallest minimum distance between any point on the front surface of the overlap portion of the outer dipole arm and the radome.

Pursuant to additional embodiments of the present invention, base station antennas are provided that include a backplane having a planar reflector, a radome having a front wall, a side wall and a curved front transition wall that connects the front wall to the side wall, the curved front transition wall of the radome having a radius of curvature of at least 75 mm, and a radiating element mounted to extend forwardly from the reflector, the radiating element including an inner dipole arm and an outer dipole arm. A distal end of the outer dipole arm is closer to the planar reflector than is a base of the outer dipole arm.

In some embodiments, a minimum distance between each point on a front surface of the outer dipole arm and the radome may vary by less than 50% or by less than 25%.

In some embodiments, the curved front transition wall may have a radius of curvature of at least 90 mm.

In some embodiments, the radiating element may be configured to operate in at least a portion of the 617-960 MHz frequency band.

In some embodiments, an overlap portion of the outer dipole arm overlaps the curved front transition wall, and a largest minimum distance between any point on a front surface of the overlap portion of the outer dipole arm and the radome may be less than 1.5 times a smallest minimum distance between any point on the front surface of the overlap portion of the outer dipole arm and the radome.

In some embodiments, the outer dipole arm may include at least two bends along a longitudinal axis of the outer dipole arm that divide the outer dipole arm into a plurality of longitudinally-extending sections that are angled with respect to each other. In some embodiments, distances between centers of each longitudinally-extending section and respective closest points on the radome may vary by less than 25%.

In some embodiments, at least half a length of the outer dipole arm may overlap the curved front transition wall.

### BRIEF DESCRIPTION OF THE DRAWINGS

FIG. 1 is a schematic cross-sectional view of a conventional base station antenna.

FIG. 2 is a schematic cross-sectional view of a base station antenna according to embodiments of the present invention.

FIG. 3A is a schematic perspective view of a radiating element having bent dipole arms.

FIG. 3B is a schematic cross-sectional view of a base station antenna according to further embodiments of the present invention that includes linear arrays of the radiating element of FIG. 3A.

FIG. 4A is a schematic side view of another radiating element having bent dipole arms.

FIG. 4B is a schematic cross-sectional view of a base station antenna according to additional embodiments of the present invention that includes linear arrays of the radiating element of FIG. 4A.

FIGS. 5A and 5B are schematic views of additional radiating elements having bent dipole arms that may be used in base station antennas according to embodiments of the present invention.

FIG. 6A is a perspective view of a base station antenna according to further embodiments of the present invention.

FIG. 6B is a schematic cross-sectional view of the base station antenna of FIG. 6A.

FIG. 6C is a front view of an antenna assembly of the base station antenna of FIG. 6A.

FIG. 6D is an enlarged perspective front view of a portion of the antenna assembly of FIG. 6A.

FIGS. 7A-7D are schematic cross-sectional views of portions of base station antennas according to yet additional embodiments of the present invention.

Two part reference numerals may be used to refer to elements that are duplicated in the base station antennas according to embodiments of the present invention. Herein, the full reference numeral (e.g., linear array 130-2) may be used to refer to a specific instance of such an element, while the first part of the reference numeral (e.g., the linear arrays 130) may be used to refer to the elements collectively.

It will be appreciated that when base station antennas are mounted for use, the radiating elements typically extend forwardly from a reflector. For convenience, many of the figures, however, depict the radiating elements and/or base station antenna rotated 90° from this configuration. The text herein describes these figures using directional references that are consistent with the orientation of the base station antennas when mounted for use as opposed to how they are shown in some of the figures.

### DETAILED DESCRIPTION

Traditionally, the radiating elements of a base station antenna and the housing of the antenna are designed independently of each other. In particular, the radiating elements will be designed based on desired RF performance characteristics for the antenna, and the housing, including the radome, is designed separately based, for example, on a known width for the reflector of the antenna and other considerations. The radome typically has a front wall and side walls, and most (but not all) radomes further include a back wall so that the radome may be formed as an open tube that surrounds and protects an antenna assembly of the base station antenna. The “corners” where the front wall meets each side wall and where the back wall meets each side wall are typically implemented as curved transition walls in order to reduce the wind loading on the antenna. In a typical antenna design, the radius of curvature of the curved front transition walls may be about 30-35 mm.

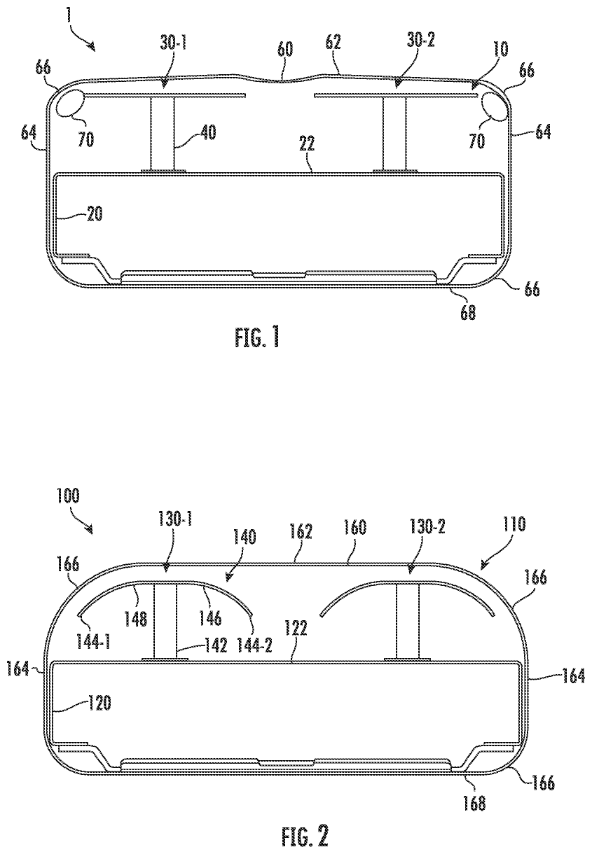

FIG. 1 is a schematic cross-sectional view of a base station antenna 1 fabricated according to the above-described conventional design process. As shown in FIG. 1, the base station includes an antenna assembly 10 and a radome 60 that surrounds and protects the antenna assembly 10. The radome 60 includes a front wall 62, a pair of side walls 64, a pair of curved front transition walls 66 that connect each side of the front wall 62 to a corresponding side wall 64, a back wall 68, and a pair of curved rear transition walls 66 that connect each side of the back wall 68 to a corresponding side wall 64. Top and bottom end caps (not shown) are provided that seal the openings at the top and bottom of the radome 60 in order to fully enclose the antenna assembly 10. The antenna assembly 10 includes, among other things, a backplane 20 having a reflector 22, and multiple linear arrays 30 of radiating elements 40 that are mounted to extend forwardly from the reflector 22. The radiating elements 30 are typically implemented as slant −45°/+45° cross-dipole radiating elements. Such cross-dipole radiating elements include a first dipole radiator that transmits and receives RF signals having a −45° polarization and a second dipole radiator that transmits and receives RF signals having a +45° polarization. Each dipole radiator is formed as a pair of dipole arms. While only two linear arrays 30 are depicted in FIG. 1, it will be appreciated that most 4G and 5G base station antennas will include a larger number of linear arrays 30 and may also include one or more planar (two dimensional) arrays of radiating elements.

As mentioned above, the curved front transition walls 66 typically have a relatively small radii of curvature. This ensures that there is room for the linear arrays 30 of radiating elements 40 to be spaced sufficiently far apart to have good isolation and also ensures that the radiating elements 40 will fit within the radome 60 with sufficient clearance so that the radiating elements 40 will not be damaged when the radome 60 flexes during handling or under wind loading. However, the conventional design process often results in empty space along the front sides of the antenna 1, which is indicated by reference numeral 70 in FIG. 1. Thus, while the conventional design process is simple, it often wastes space within the antenna 1 and may not allow for the curved front transition walls 66 of the radome to each have a large radius of curvature.

Pursuant to embodiments of the present invention, the design process for the radiating elements and the antenna housing may be performed as a combined process so that the “outer” dipole arms of the radiating elements 40 (i.e., the dipole arms that extend close to the side walls of the radome 60) conform, at least to an extent, to the shape of the curved front transition walls of the radome 60. This can be accomplished, for example, by bending at least a portion of each outer dipole arm rearwardly into the space 70 shown in FIG. 1. By bending the outer dipole arms rearwardly, an empty space is created adjacent the curved front transition walls 66 of the radome 60, which allows for the curved front transition walls 66 to have a larger radius of curvature, which can significantly improve the wind loading performance of the base station antenna.

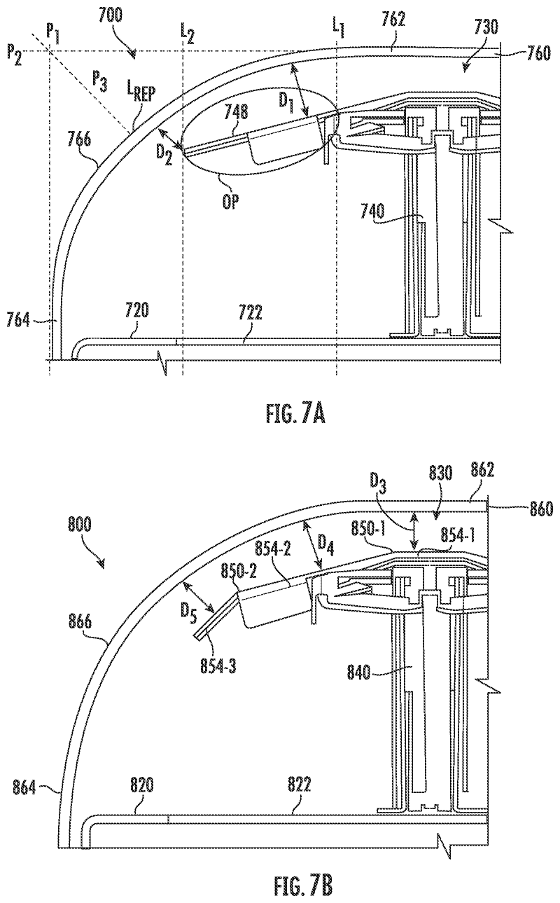

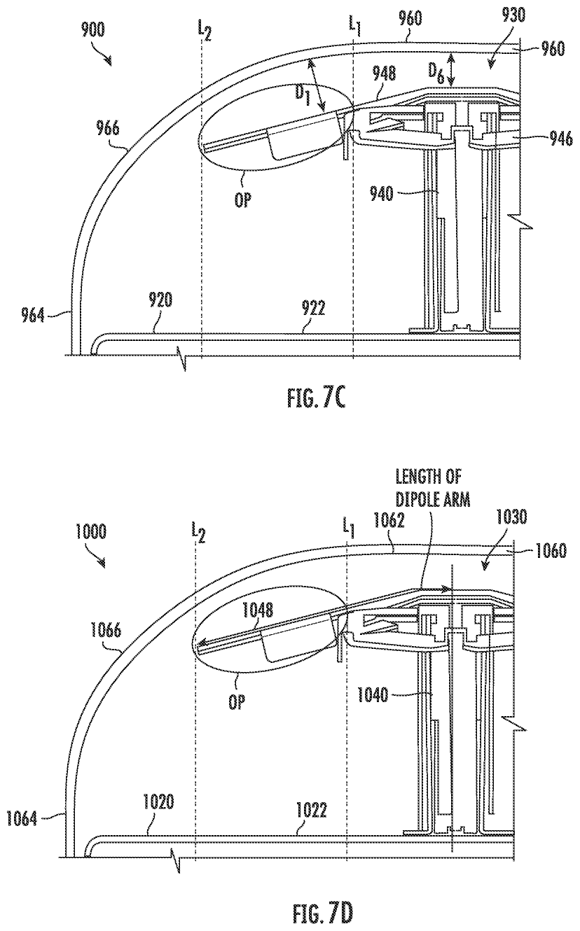

In some embodiments, base station antennas are provided that include a planar reflector, a radiating element mounted to extend forwardly from the planar reflector, and a radome. The radiating element may include a dipole that has an inner dipole arm and an outer dipole arm. The radome has a front wall, a side wall and a curved front transition wall that connects the front wall to the side wall. The outer dipole arm is bent so that a distal end of the outer dipole arm is closer to the planar reflector than is a base of the outer dipole arm. An overlap portion of the outer dipole arm “overlaps” the curved front transition wall. As discussed herein with reference to FIG. 7A, the portion of portion of a dipole arm that overlaps a curved transition wall of a radome is the portion of the dipole arm that is between a first axis that is perpendicular to the reflector that extends from an inner edge of the curved transition wall and a second axis that is perpendicular to the reflector that extends through the distal end of the dipole arm. The outer dipole arm and the radome are designed so that a largest minimum distance between any point on a front surface of the overlap portion of the outer dipole arm and the radome is less than twice a smallest minimum distance between any point on the front surface of the overlap portion of the outer dipole arm and the radome.

In further embodiments, base station antennas are provided that have a planar reflector, a radiating element that includes an inner dipole arm and an outer dipole arm mounted to extend forwardly from the reflector, and a radome that has a front wall that is positioned in front of the radiating element. The outer dipole arm includes at least two bends along a longitudinal axis of the outer dipole arm that divide the outer dipole arm into a plurality of longitudinally-extending sections that are angled with respect to the reflector and with respect to each other, where distances between centers of each longitudinally-extending section and respective closest points on the radome vary by less than 50%.

In yet additional embodiments, base station antennas are provided that include a reflector, a radiating element that includes an inner dipole arm and an outer dipole arm mounted to extend forwardly from the reflector, and a radome having a front wall, a side wall and a curved front transition wall that connects the front wall to the side wall. The curved front transition wall may have a radius of curvature of at least 50 mm. An overlap portion of the outer dipole arm overlaps the curved front transition wall. Moreover, a largest minimum distance between any point on a front surface of the overlap portion of the outer dipole arm and the radome is less than 1.5 times a minimum distance between the front wall of the radome and the front surface of the outer dipole arm.

According to still further embodiments, base station antennas are provided that include a backplane having a planar reflector, a radome having a front wall, a side wall and a curved front transition wall that connects the front wall to the side wall, the curved front transition wall of the radome having a radius of curvature of at least 75 mm, and a radiating element mounted to extend forwardly from the reflector, the radiating element including an inner dipole arm and an outer dipole arm.

Example base station antennas according to embodiments of the present invention will now be discussed in greater detail with reference to FIGS. 2-7D.

FIG. 2 is a schematic cross-sectional view of a base station antenna 100 according to certain embodiments of the present invention. As shown in FIG. 2, the base station antenna 100 includes an antenna assembly 110 and a radome 160. The radome 160 includes a front wall 162, a pair of side walls 164, a pair of curved front transition walls 166 that connect each side of the front wall 162 to a corresponding side wall 164, a back wall 168, and a pair of curved rear transition walls 166 that connect each side of the back wall 168 to a corresponding side wall 164. The antenna assembly 110 includes a backplane 120 having a reflector 122, and multiple linear arrays 130 of radiating elements 140 that are mounted to extend forwardly from the reflector 122. Each radiating element 140 includes a feed stalk 142 and a pair of dipole radiators 144-1, 144-2 that are electrically connected to the forward end of the feed stalk 142. Each dipole radiator 144 includes an inner dipole arm 146 that extends toward the longitudinal centerline of the base station antenna 100 and an outer dipole arm 148 that extends toward a side wall 164 of the radome 160. In the cross-sectional view of FIG. 2, only half of each dipole radiator 144 is visible (namely the outer dipole arm 148 of dipole radiator 144-1, and the inner dipole arm 146 of dipole radiator 144-2).

As shown in FIG. 2, the inner dipole arms 146 and the outer dipole arms 148 each are bent rearwardly so that the distal end of each dipole arm 146, 148 is closer to the reflector 122 than is the base of each dipole arm 146, 148 (where the base is the portion of each dipole arm 146, 148 that is mounted on the feed stalk 142). In the base station antenna of FIG. 2, each dipole arm 146, 148 includes a continuous bend so that the dipole arms 146, 148 have a continuous arcuate profile as opposed to simply having one or more discrete bends as is the case with base station antennas according to various other embodiments of the present invention.

Since the outer dipole arms 148 are bent rearwardly, they do not extend as far into the front corner regions of the radome 160 as do the outer dipole arms of the radiating elements 40 of the conventional base station antenna 1. Consequently, the curved front transition walls 166 of radome 160 may have larger radii of curvature as compared to the corresponding curved front transition walls 66 of radome 60 of the conventional base station antenna 1. The additional curvature in the walls of radome 166 may significantly improve the wind loading performance of base station antenna 100 as compared to conventional base station antenna 1. In example embodiments, the radius of curvature may be extended from about 30 mm in the conventional antenna 1 to 50 mm, 60 mm, 70 mm, 80 mm, 90 mm 100 mm or more in base station antenna 100. By forming the front corner walls of the radome 160 to have larger radii of curvature the wind loading performance of the antenna 100 may be improved considerably. Moreover, since the radome 160 may be designed in conjunction with the radiating elements 140, the radome 160 may be made to generally conform to the shape of the outer dipole arms (and vice versa) so that a maximum improvement in wind loading performance may be achieved. In some embodiments of the present invention, the curved front transition wall may not have a constant radius of curvature. In such embodiments, the radius of curvature of the curved front transition wall is considered to be the radius of curvature of a representative line Lᵣₑₚ on the curved front transition wall of the radome. The representative line Lᵣₑₚ is a line that is defined by three planes P₁ through P₃, where plane P₁ is a plane that is parallel to the reflector that intersects the forward most point of the front wall of the radome, plane P₂ is a plane that is perpendicular to plane P₁ that intersects the leftward (or rightward) most point on the left (or right) side wall of the radome, and plane P₃ is a plane that extends at an angle of 45° from the line defined by the intersection of planes P₁ and P₂. The line Lᵣₑₚ is normal to plane P₃. Planes P₁-P₃ and Lᵣₑₚ are shown in FIG. 7A.

Typically, performance parameters will be established for the linear arrays 130 of radiating elements 140 in terms of antenna pattern size (e.g., azimuth and elevation beamwidths), antenna pattern shape (e.g., gain roll off, sidelobe and grating lobe levels), return loss, cross-polarization performance, and various other performance parameters. The radiating elements 140 may be designed to meet these performance parameters. Bending the dipole arms 146, 148 rearwardly may, in many cases, act to improve some performance parameters (e.g., cross-polarization performance) while degrading other performance parameters (e.g., impedance match/return loss, which impacts the operating bandwidth of the linear array 130). As part of the design process, the extent to which the outer dipole arms 148 are bent rearwardly (through one or more bends in each outer dipole arm 148) may be varied to ensure that the linear arrays 130 meet the minimum performance requirements. In some cases, a maximum amount of bending may be applied (i.e., the extent to which the outer dipole arms 148 are bent rearwardly is increased until a performance parameter is barely achieved) so that the radius of curvature of the curved front transition walls 166 may be increased as much as possible. In other cases, the designers may weigh the increase in wind loading performance against any decrease in RF performance and select an amount of bend in the outer dipole arms 148 that provides a good tradeoff between the different performance parameters. In still other embodiments, more complex tradeoffs and design changes may be made. For example, while bending the dipole arms 148 rearwardly tends to degrade the return loss performance of the linear arrays 130, increasing the length of the feed stalk 142 (i.e., how far the feed stalk 142 extends in the forward direction) may act to counter the degradation in return loss performance. Thus, in some cases, it may be advantageous to lengthen the feed stalks 142 (which increases the depth of the antenna 100, which degrades wind loading performance in certain directions) in order to allow increased bending of the outer dipole arms 148 in order to increase the radius of curvature on each of the curved front transition walls 166 of the radome 160.

As described above, by designing the radiating elements 140 and the radome 160 in parallel, base station antennas may be provided that achieve improved wind loading performance while meeting all RF performance parameters. In essence, compromises between RF performance and wind loading performance may be considered to provide a base station antenna that exhibits overall improved performance. This approach also may act to reduce the amount of wasted empty space in the antenna, and may reduce material costs (since the size of the radome may be reduced).

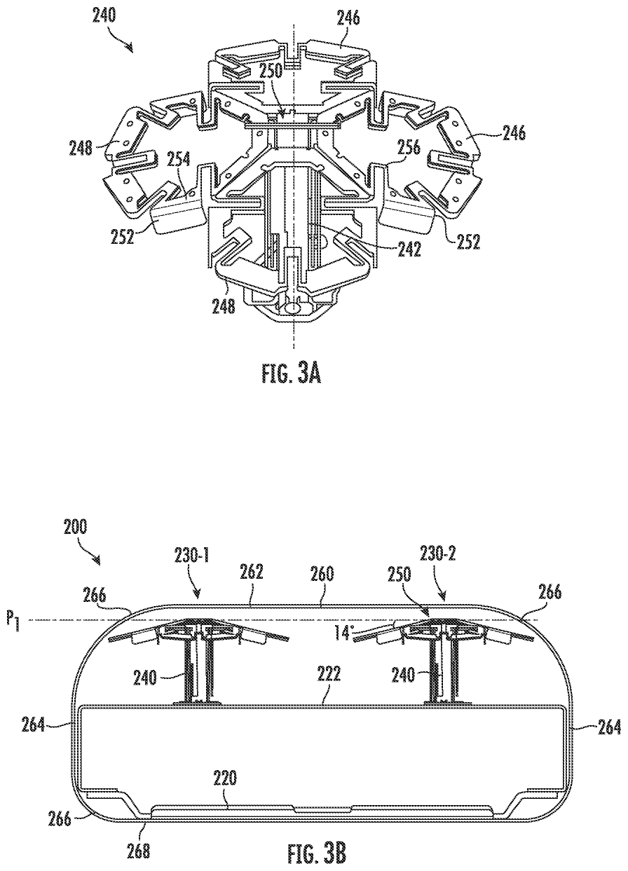

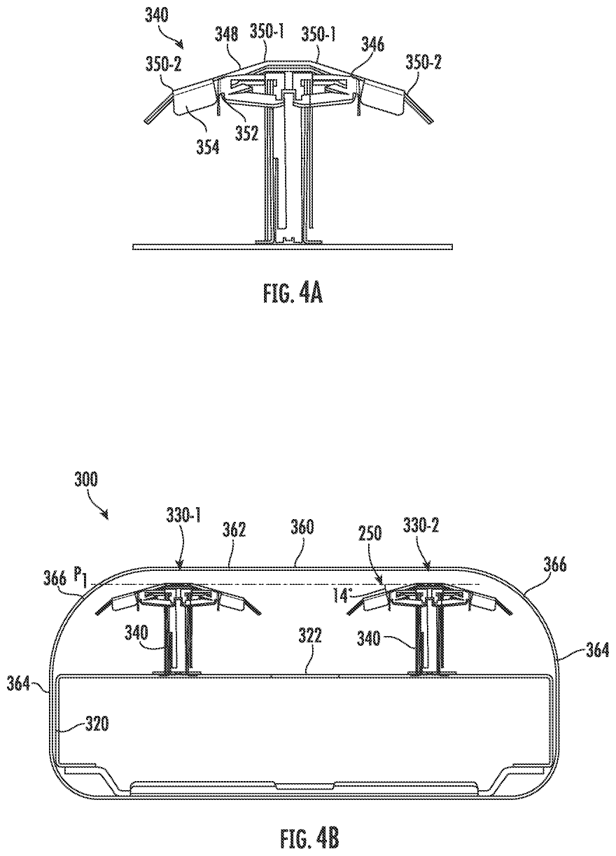

While FIG. 2 illustrates one possible design for radiating elements having bent dipole arms that may be used in the base station antennas according to embodiments of the present invention, it will be appreciated that a wide variety of bent dipole arm designs may be used. FIGS. 3A-3B and 4A-4B illustrate base station antennas according to further embodiments of the present invention that include radiating elements having example alternative bent dipole arm designs.

FIG. 3A is a perspective view of a radiating element 240 having dipole arms 246, 248 that are slanted rearwardly. FIG. 3B is a cross-sectional view of a base station antenna 200 according to embodiments of the present invention.

As shown in FIG. 3B, the base station antenna 200 includes a backplane 220 that has a front metal surface 222 and a radome 260. The radome 260 includes a front wall 262, a pair of side walls 264, a pair of curved front transition walls 266 that connect each side of the front wall 262 to a corresponding side wall 264, a back wall 268, and a pair of curved rear transition walls 266 that connect each side of the back wall 268 to a corresponding side wall 264. A pair of linear arrays 230 are mounted to extend forwardly from the reflector 222. The radome 260 surrounds the backplane 220 and the linear arrays 230 in order to protect the internal components of the antenna 200 from the outside environment. Only one radiating element 240 of each linear array 230 is visible in the cross-sectional view of FIG. 3B.

The linear arrays 230 may be, for example, linear arrays of radiating elements 240 that are configured to operate in all or part of the 617-960 MHz frequency band. In modern base station antennas, radiating elements that operate in all or part of the 617-960 MHz frequency band are typically referred to as “low-band” radiating elements as this frequency band is typically the lowest frequency range used for cellular communications. The low-band radiating elements are typically the largest radiating elements included in the antenna, since the size of a radiating element is generally inversely proportional to the center frequency of the operating frequency band of the radiating element. Thus, the linear arrays 230 of low-band radiating elements 240 tend to drive the depth of the radome 260 as well as the radius of curvature of the curved front transition walls 266 of the radome 260. Each low-band linear array 230 may have any appropriate number of radiating elements 240 (with the number of radiating elements 240 typically selected to achieve a desired elevation beamwidth for the antenna beams generated by the linear arrays 230). It will also be appreciated that additional linear arrays of radiating elements (not shown) such as mid-band linear arrays formed of radiating elements that operate in all or part of the 1427-2690 MHz frequency band or high-band linear arrays formed of radiating elements that operate in all or part of the 3100-4200 MHz frequency band and/or the 5100-5800 MHz frequency band may also be included in base station antenna 200. These additional linear arrays are omitted from FIG. 3B since they do not tend to impact the radius of curvature of the curved front transition walls 266 of the radome 260. The radiating elements 240 may include a plastic support, which is not shown in the figures views to better illustrate the rearward slant of the dipole arms 246, 248.

Referring now to FIG. 3A, the inner and outer dipole arms 246, 248 of radiating element 240 each include a single primary bend 250 that is near the base of each dipole arm 246, 248. In the depicted embodiment, each dipole arm 246, 248 is bent rearwardly at an angle of about 14° with respect to a plane P₁ that is parallel to the reflector 222 (FIG. 3B) of base station antenna 200. While bending the inner dipole arms 246 typically will not allow for changes to the radome design that will improve the wind loading performance of the antenna, the inner dipole arms 246 are typically bent similarly or identically to the outer dipole arms 248 in order to maintain good symmetry for the radiation patterns (“antenna beams”) generated by each linear array 230 of base station antenna 200 (and this is also true with respect to the other example radiating elements disclosed herein).

Each dipole arm 246, 248 may have a generally oval shape and may be formed as a series of widened sections 254 that are connected by narrowed inductive traces 256. This may help make the dipole arms 246, 248 relatively transparent to RF energy within the operating frequency bands of any mid-band and/or high-band linear arrays of radiating elements included in base station antenna 200. In some embodiments, the dipole arms 246, 248 may have the design disclosed in U.S. Pat. No. 10,770,803 (“the '803 patent”), except that the radiating element 240 further includes the primary bends 250 and secondary bends 252 (discussed below) in each dipole arm 246, 248. The disclosure of the '803 patent is incorporated herein by reference as if set forth fully herein.

Each dipole arm 246, 248 also includes a pair of secondary bends 252 where outer portions of selected of the widened segments 254 of the dipole arm 246, 248 are bent at a sharp angle (here about 90°) with respect to a plane P₁. The secondary bends 252 act to increase the electrical length of each dipole arm 246, 248 without increasing the “footprint” of the dipole arm 246, 248 (i.e., the perimeter of the dipole arm 246, 248 when the radiating element 240 is viewed from the front). This allows the overall physical length of each dipole arm 246, 248 to be reduced, which may also allow for increasing the radius of curvature of each of the curved front transition walls 266 or, alternatively, reducing the overall width of the base station antenna 200, both of which may improve the wind loading performance of the antenna 200. Herein, a primary bend in a dipole refers to a bend that angles the distal end of the dipole arm rearwardly from a plane defined by the bases of the dipole arms that is parallel to the reflector of the base station antenna.

Referring again to FIG. 3B, it can be seen that the primary rearward bends 250 in the outer dipole arms 248 allow the radius of curvature of each of the curved front transition walls 266 of the radome 260 to be increased. This may improve the wind loading performance of base station antenna 200. Since only one primary bend 250 is provided in each outer dipole arm 248, the outer dipole arms 248 only very generally conform to the shape of the curved front transition walls 266 of the radome 260. However, by comparing FIGS. 1 and 3B, it can be seen that even providing a single bend may allow the radius of curvature of each of the curved front transition walls 266 of the radome 260 to be increased significantly.

FIG. 4A is a side view of a radiating element 340 having inner and outer dipole arms 346, 348 that are slanted rearwardly, and FIG. 4B is a cross-sectional view of a base station antenna 300 according to embodiments of the present invention that includes linear arrays 330 of the radiating element 340.

As shown in FIGS. 4A-4B, the base station antenna 300 includes a backplane 320 that has a front metal surface 322 and a radome 360. The radome 360 includes, among other things, a front wall 362, a pair of side walls 364, and a pair of curved front transition walls 366 that connect each side of the front wall 362 to a corresponding side wall 364. A pair of low-band linear arrays 330-1, 330-2 of radiating elements 340 that are configured to operate in all or part of the 617-960 MHz frequency band are mounted to extend forwardly from the reflector 322. The radome 360 surrounds the backplane 320 and the linear arrays 330. Additional arrays of mid-band and/or high-band radiating elements (not shown) may also be included in base station antenna 300. The radiating elements 340 may include a plastic support, which is not shown in the figures.

The radiating elements 340 comprise −45°/+45° cross-dipole radiating elements. Each radiating element 340 includes a pair of dipole radiators, and each dipole radiator includes an inner dipole arm 346 and an outer dipole arm 348. Only one inner dipole arm 346 and one outer dipole arm 348 are visible in the views of FIGS. 4A-4B. The inner and outer dipole arms 346, 348 of each radiating element 340 each include a pair of primary bends 350-1, 350-2. The first primary bend 350-1 may be near the base of each dipole arm 346, 348. In the depicted embodiment, the first primary bends 350-1 angle each dipole arm 346, 348 rearwardly at an angle of about 14° with respect to a plane P₁ that is parallel to the reflector 322 (FIG. 4B). Each second primary bend 350-2 may be in a middle portion or near the distal end of the dipole arm 346, 348. The second primary bends 350-2 may be at a larger angle with respect to the plane P₁ than the first primary bends 350-1. As with radiating element 240, each dipole arm 346, 348 in radiating element 340 further includes a pair of secondary bends 352 where an outer portion of a widened segment 354 of the dipole arm 346, 348 is bent at a sharp angle with respect to the plane P₁. As can be seen from FIG. 4B, including two primary rearward bends 350 in the outer dipole arms 348 allows the radius of curvature of each of the curved front transition walls 366 of the radome 360 to be increased further than is the case in base station antenna 200, which may further improve the wind loading performance of base station antenna 300. The outer dipole arms 348 also may exhibit improved conformity with the shape of the curved front transition walls 366 of the radome 360. It will be appreciated that in other embodiments more than two primary bends 350 may be provided in each outer dipole arm 348.

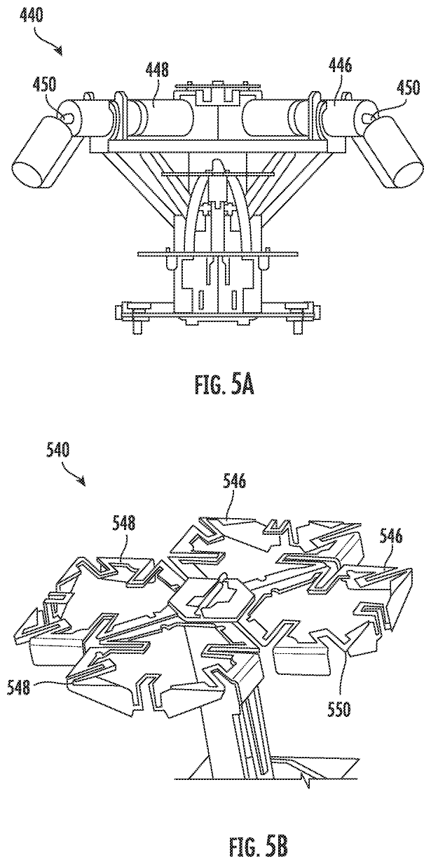

It will be appreciated that a wide variety of different dipole arm designs may be used that allow for increasing the radius of curvature of each curved front transition wall of the radome of a base station antenna. FIGS. 5A and 5B illustrate two additional example radiating element designs that could be used in the base station antennas according to embodiments of the present invention. As shown in FIG. 5A, a cross-dipole radiating element 440 includes a pair of inner dipole arms 446 (only one of which is visible in the figure) and a pair of outer dipole arms 448 (only one of which is visible in the figure) that are formed as a series of dipole segments with RF chokes disposed between adjacent dipole segments. The dipole arms 446, 448 may have the general design shown in FIGS. 2A-2B and 3 of U.S. Pat. No. 10,644,401 (“the '401 patent”), except that each dipole arm 446, 448 may have an electrical length of about ¼ of a wavelength corresponding to the center frequency of the operating frequency band for the radiating element 440. The entire content of the '401 patent is incorporated herein by reference. Additionally, as shown in FIG. 5A, a primary bend 450 is formed in each dipole arm 446, 448 between the outer two dipole segments so that the distal end of each dipole arm 446, 448 is angled rearwardly.

In some embodiments, radiating elements may be used that have dipole arms with a primary bend that is a large angle. For example, FIG. 5B illustrates a radiating element 540 that may be viewed as a modified version of either radiating element 240 of FIG. 3A or radiating element 340 of FIG. 4A. Each inner and outer dipole arm 546, 548 of radiating element 540 includes a primary bend of about 90° so that the distal end of each dipole arm 546, 548 points rearwardly toward the reflector of the base station antenna. Such a design may also allow increasing the radius of curvature of the curved front transition walls of the radome.

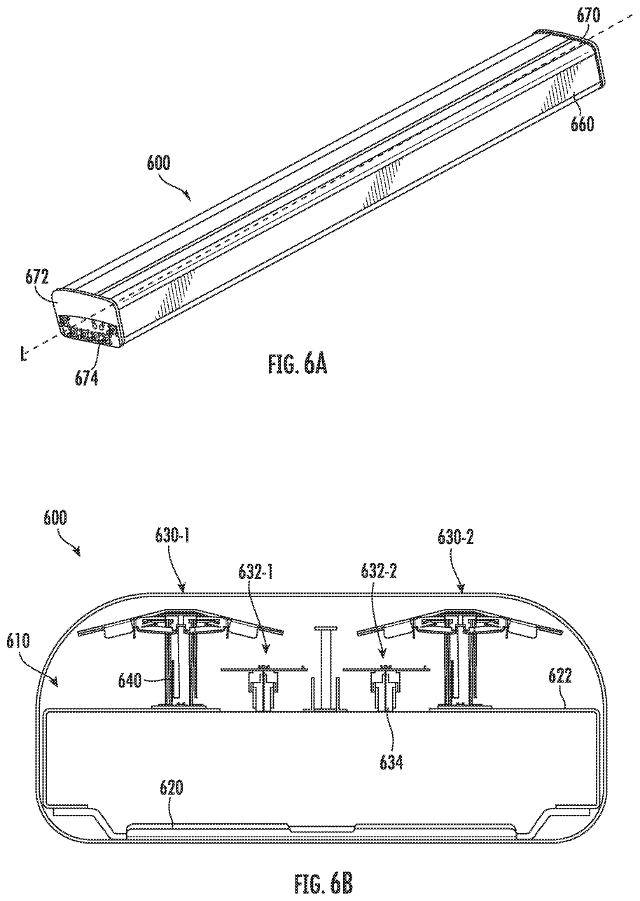

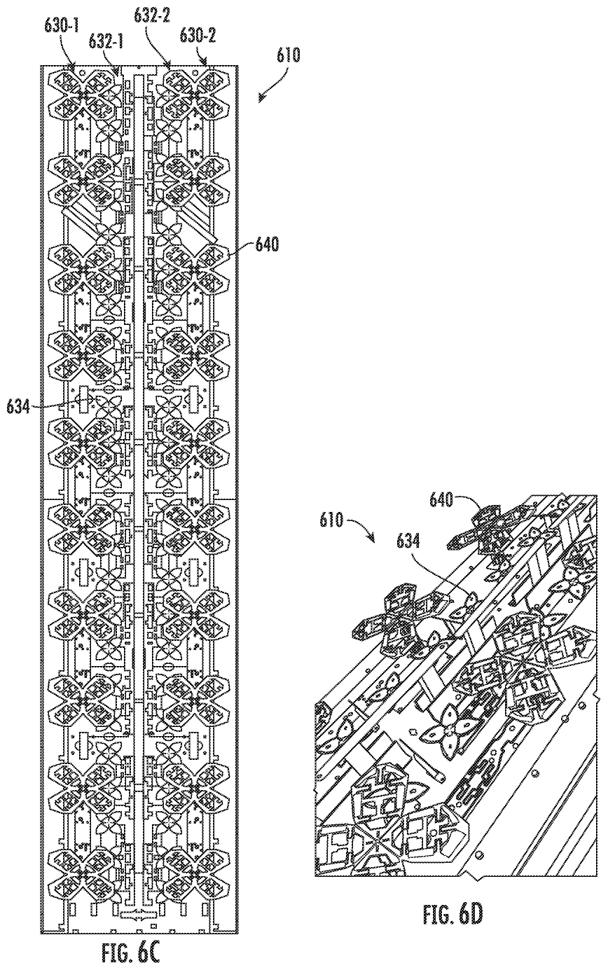

FIGS. 6A-6D illustrate a base station antenna 600 according to embodiments of the present invention in further detail. In particular, FIG. 6A is a side perspective view of the base station antenna 600. FIG. 6B is a schematic cross-sectional view of the base station antenna 600 that illustrates the relationship of the radiating elements with respect to the radome. It will be noted that the radome supports as well as various components that are mounted behind the reflector of base station antenna 600 are omitted from FIG. 6B to simplify the drawing. FIG. 6C is a schematic front view of an antenna assembly 610 of base station antenna 600, and FIG. 6D is an enlarged front perspective view of a portion of the antenna assembly 610.

As shown in FIG. 6A, the base station antenna 600 is an elongated structure that extends along a longitudinal axis L. The antenna 600 includes a radome 660 and a top end cap 670. The radome 660 has a tubular shape with a generally rectangular cross-section having radiused corners. The radius of curvature for the front corners may be different than the radius of curvature for the rear corners of the radome 660. The antenna 600 also includes a bottom end cap 672 which includes a plurality of RF connector ports 674 mounted therein. The RF connector ports 674 may be connected to corresponding ports of one or more radios via cabling connections (not shown). The antenna 600 is typically mounted in a vertical configuration (i.e., the longitudinal axis L may be generally perpendicular to a plane defined by the horizon) when the antenna 600 is mounted for normal operation. The radome 660, top cap 670 and bottom cap 672 may form an external housing for the antenna 600. An antenna assembly 610 (FIGS. 6B-6D) is contained within the housing. The antenna assembly 610 may be slidably inserted into the radome 660, typically from the bottom before the bottom cap 664 is attached to the radome 660.

As shown in FIGS. 6B-6D, the antenna assembly 610 includes a backplane 620 that includes a reflector 622. The reflector 622 may comprise a metallic sheet that serves as a ground plane for the radiating elements that are mounted thereon, and also acts to redirect forwardly much of the backwardly-directed radiation emitted by these radiating elements. The base station antenna 600 further includes two low-band linear arrays 630-1, 630-2 of low-band radiating elements 640 and two mid-band linear arrays 632-1, 632-2 of mid-band radiating elements 634. Each low-band radiating element 640 is mounted to extend forwardly from the reflector 622, and may be configured to transmit and receive RF signals in the 617-960 MHz frequency band or a portion thereof. While the radiating elements 640 are shown as being identical to the radiating elements 240 discussed above, it will be appreciated that a wide variety of radiating elements with rearwardly bent dipole arms could be used in place of radiating elements 640. Similarly, each mid-band radiating element 634 is mounted to extend forwardly from the reflector 622, and may be configured to transmit and receive RF signals in the 1427-2690 MHz frequency band or a portion thereof. The mid-band linear arrays 632 are positioned between the low-band linear arrays 630, although embodiments of the present invention are not limited thereto. For example, in other embodiments, two additional mid-band linear arrays 632 could be provided that are positioned outside the respective low-band linear arrays 630.

The base station antennas according to embodiments of the present invention may more efficiently utilize the space inside the radome, which may allow for increasing the radius of curvature of the curved forward transition walls of the radome, which may improve the wind loading performance of the antenna.

FIGS. 7A-7D illustrate the design of base station antennas according to further embodiments of the present invention.

Referring to FIG. 7A, in some embodiments, base station antennas 700 are provided that include a backplane 720 having a planar reflector 722, an array 730 of radiating elements 740 mounted to extend forwardly from the reflector 722, and a radome 760 having a front wall 762 that is positioned in front of the radiating elements 740, a side wall 764 and a curved front transition wall 766 that connects the front wall 762 to the side wall 764. Each radiating element 740 may include a dipole that has an inner dipole arm 746 and an outer dipole arm 748. The outer dipole arm 748 is bent so that a distal end of the outer dipole arm 748 is closer to the reflector 722 than is a base of the outer dipole arm 748. A portion of the outer dipole arm 748 overlaps the curved front transition wall 766 of the radome 760. As discussed above, the portion of a dipole arm that overlaps a curved transition wall of a radome is the portion of the dipole arm that is between a first axis L₁ that is perpendicular to the reflector on which the radiating element 740 is mounted that extends from an inner edge of the curved transition wall and a second axis L₁ that is perpendicular to the reflector that extends through the distal end of the dipole arm. In the base station antenna of FIG. 7A, the portion of the outer dipole arm 748 overlaps the curved front transition wall 766 of the radome 760 is the portion labelled “OP.” As is further shown in FIG. 7A, in some embodiments, a largest minimum distance D₁ between any point on the front surface of the overlap portion OP of the outer dipole arm 748 and the radome 760 (the largest minimum distance D₁ is the maximum distance between the front surface of the overlap portion OP of the outer dipole arm 748 and the closest point thereto on the radome 760) is less than twice a smallest minimum distance D₂ between any point on the front surface of the overlap portion OP of the outer dipole arm 748 and the radome 760 (the smallest minimum distance D₂ is the minimum distance between the front surface of the overlap portion OP of the outer dipole arm 748 and the radome 760). In other embodiments, the distance D₁ may be less than 1.5 times D₂, less than 1.3 times D₂ or less than 1.2 times D₂.

Referring to FIG. 7B, in further embodiments, base station antennas 800 are provided that include a backplane 820 having a planar reflector 822, an array 830 of radiating elements 840 mounted to extend forwardly from the reflector 822, and a radome 860 having a front wall 862 that is positioned in front of the radiating elements 840, a side wall 864 and a curved front transition wall 866 that connects the front wall 862 to the side wall 864. Each radiating element 840 in the linear array 830 includes an inner dipole arm 846 and an outer dipole arm 848 mounted to extend forwardly from the reflector 822. The outer dipole arm 848 includes at least two bends 850-1, 850-2 along a longitudinal axis of the outer dipole arm 848. The bends 850 divide the outer dipole arm 848 into a plurality of longitudinally-extending sections 854-1, 854-2, 854-3 that are angled with respect to the reflector 822 and with respect to each other. As shown in FIG. 7B, distances D₃, D₄ and D₅ between centers of each longitudinally-extending section 854 and respective closest points on the radome 860 vary by less than 50%.

Referring to FIG. 7C, in yet additional embodiments, base station antennas 900 are provided that include a reflector 922, and an array 930 of radiating elements 940. Each radiating element 940 includes an inner dipole arm 946 and an outer dipole arm 948 mounted to extend forwardly from the reflector 922, and a radome 960 having a front wall 962, a side wall 964 and a curved front transition wall 966 that connects the front wall 962 to the side wall 964. The curved front transition wall 966 may have a radius of curvature of at least 50 mm. An overlap portion OP of the outer dipole arm 948 overlaps the curved front transition wall 966. Moreover, the largest minimum distance D₁ between any point on a front surface of the overlap portion OP of the outer dipole arm 948 and the radome 960 is less than 1.5 times a minimum distance D₆ between the front wall 962 of the radome 960 and the front surface of the outer dipole arm 948.

Referring to FIG. 7D, according to still further embodiments, base station antennas 1000 are provided that include a backplane having a planar reflector 1022, a radome 1060 having a front wall 1060, a side wall 1064 and a curved front transition wall 1066 that connects the front wall 1062 to the side wall 1064, the curved front transition wall 1066 of the radome 1060 having a radius of curvature of at least 75 mm, and an array 1030 of radiating elements 1040 mounted to extend forwardly from the reflector 1022. Each radiating element 1040 has an inner dipole arm 1046 and an outer dipole arm 1048. A distal end of the outer dipole arm 1048 is closer to the reflector 1022 than is a base of the outer dipole arm 1048. In some embodiments, at least half a length of the outer dipole arm 1048 overlaps the curved front transition wall 1066 of the radome 1060.

The base station antennas according to embodiments of the present invention may provide improved performance as compared to comparable conventional base station antennas.

It will be appreciated that the present specification only describes a few example embodiments of the present invention and that the techniques described herein have applicability beyond the example embodiments described above.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a backplane having a planar reflector;
a radiating element mounted to extend forwardly from the planar reflector, the radiating element including a dipole that comprises an inner dipole arm and an outer dipole arm; and
a radome having a front wall, a side wall and a curved front transition wall that connects the front wall to the side wall;
wherein a distal end of the outer dipole arm is closer to the planar reflector than is a base of the outer dipole arm,
wherein an overlap portion of the outer dipole arm overlaps the curved front transition wall, and
wherein a largest minimum distance between any point on a front surface of the overlap portion of the outer dipole arm and the radome is less than twice a smallest minimum distance between any point on the front surface of the overlap portion of the outer dipole arm and the radome.

2. The base station antenna of claim 1, wherein the overlap portion of the outer dipole arm comprises at least half a length of the outer dipole arm.

3. The base station antenna of claim 1, wherein the curved front transition wall has a radius of curvature of at least 50 mm.

4. The base station antenna of claim 1, wherein the curved front transition wall has a radius of curvature of at least 75 mm.

5. The base station antenna of claim 1, wherein the radiating element is configured to operate in at least a portion of the 617-960 MHz frequency band.

6. The base station antenna of claim 1, wherein the largest minimum distance between any point on the front surface of the overlap portion of the outer dipole arm and the radome is less than 1.5 times the smallest minimum distance between any point on the front surface of the overlap portion of the outer dipole arm and the radome.

7. The base station antenna of claim 1, wherein the largest minimum distance between any point on the front surface of the overlap portion of the outer dipole arm and the radome is less than 1.25 times the smallest minimum distance between any point on the front surface of the overlap portion of the outer dipole arm and the radome.

8. The base station antenna of claim 1, wherein the outer dipole arm includes at least two bends along a longitudinal axis of the outer dipole arm that divide the outer dipole arm into a plurality of longitudinally-extending sections that are angled with respect to each other.

9. The base station antenna of claim 8, wherein distances between centers of each longitudinally-extending section and respective closest points on the radome vary by less than 25%.

10. A base station antenna, comprising:
a backplane having a reflector;
a radiating element mounted to extend forwardly from the reflector, the radiating element including an inner dipole arm and an outer dipole arm; and
a radome that has a front wall that is positioned in front of the radiating element,
wherein the outer dipole arm includes at least two bends along a longitudinal axis of the outer dipole arm that divide the outer dipole arm into a plurality of longitudinally-extending sections that are angled with respect to the reflector and with respect to each other, where distances between centers of each longitudinally-extending section and respective closest points on the radome vary by less than 50%.

11. The base station antenna of claim 10, wherein the distances between the centers of each longitudinally-extending section and the respective closest points on the radome vary by less than 25%.

12. The base station antenna of claim 10, wherein the radome further includes a side wall and a curved front transition wall that connects the front wall to the side wall, and wherein the curved transition wall has a radius of curvature of at least 50 mm.

13. The base station antenna of claim 10, wherein the radome further includes a side wall and a curved front transition wall that connects the front wall to the side wall, and wherein the curved transition wall has a radius of curvature of at least 90 mm.

14. The base station antenna of claim 10, wherein the radiating element is configured to operate in at least a portion of the 617-960 MHz frequency band.

15. The base station antenna of claim 10, wherein the radome further includes a side wall and a curved front transition wall that connects the front wall to the side wall, and wherein an overlap portion of the outer dipole arm overlaps the curved front transition wall comprises at least half a length of the outer dipole arm.

16. The base station antenna of claim 15, wherein a largest minimum distance between any point on a front surface of the overlap portion of the outer dipole arm and the radome is less than 1.5 times a smallest minimum distance between any point on the front surface of the overlap portion of the outer dipole arm and the radome.

17. A base station antenna, comprising:
a reflector;
a radome having a front wall, a side wall and a curved front transition wall that connects the front wall to the side wall, the curved front transition wall having a radius of curvature of at least 50 mm; and
a radiating element mounted to extend forwardly from the reflector, the radiating element including an inner dipole arm and an outer dipole arm,
wherein an overlap portion of the outer dipole arm overlaps the curved front transition wall, and
wherein a largest minimum distance between any point on a front surface of the overlap portion of the outer dipole arm and the radome is less than 1.5 times a minimum distance between the front wall of the radome and the front surface of the outer dipole arm.

18. The base station antenna of claim 17, wherein the curved front transition wall has a radius of curvature of at least 90 mm.

19. The base station antenna of claim 17, wherein the radiating element is configured to operate in at least a portion of the 617-960 MHz frequency band.

20. The base station antenna of claim 17, wherein the largest minimum distance between any point on the front surface of the overlap portion of the outer dipole arm and the radome is less than 1.5 times a smallest minimum distance between any point on the front surface of the overlap portion of the outer dipole arm and the radome.

21.-29. (canceled)
